(19) United States
(12) Patent Application Publication
(10) Pub. No.: US 2013/0073427 A1
(43) Pub. Date: Mar. 21, 2013

(54) STORE INFORMATION PRESENTATION SYSTEM AND SERVER DEVICE

(71) Applicants: Ryu SASAKI, Minato-ku (JP); Kiyohiko YAMANE, Minato-ku (JP)

(72) Inventors: Ryu SASAKI, Minato-ku (JP); Kiyohiko YAMANE, Minato-ku (JP)

(73) Assignee: KONAMI DIGITAL ENTERTAINMENT CO., LTD., Tokyo (JP)

(21) Appl. No.: 13/607,291

(22) Filed: Sep. 7, 2012

(30) Foreign Application Priority Data
Sep. 20, 2011 (JP) 2011-205189

(51) Int. Cl. G06Q 30/00

(52) U.S. Cl. 705/26.9

(57) ABSTRACT

In a store information presentation system which is connected to perform communication with a plurality of game machines installed in stores, a server and a user terminal which transmits position information to the server, each of the plurality of game machines transmits installation information including a game machine code used to individually identify the game machine and a store code used to individually identify the store to the server, the server manages the game machine code and the store code, specifies the store closest the position represented by the position information received from the user terminal with reference to the game machine list and the store list and transmits store information of specified store to the user terminal, and the user terminal presents a user with the store information received from the server.

### CROSS-REFERENCE TO RELATED APPLICATIONS

The present application claims the benefit of patent application number 2011-205189, filed in Japan on Sep. 20, 2011, the subject matter of which is hereby incorporated herein by reference.

### TECHNICAL FIELD

The present invention relates to, a store information presentation system and the like that presents information of a store optimal for a user among a plurality of stores in which a game machine is installed.

### BACKGROUND ART

A game machine installed in a store is connected to a server device operated by a service administrator via a network. Information of a store and information of a game machine installed in a store are managed by the service device (for example, see Patent Literature 1).

Patent Literature 1: JP-A-2010-262389.

### SUMMARY OF INVENTION

### Technical Problem

When it is desired to play with a game machine of a type installed in a store, it is difficult for a user to play with the game machine unless the user knows a store in which the game machine is installed. Further, even though the user knows a store in which the game machine is installed, since the user is not necessarily located near the store, the user may lose an opportunity to play with the game machine.

Thus, the present invention aims to provide a store information presentation system and a server device, which are capable of presenting information of a store optimal for a user based on position information.

### Solution to Problem

The store information presentation system of the present invention is a store information presentation system comprising: a plurality of game machines which are installed in stores; a server device which is connected to perform communication with the plurality of game machines; and a user terminal which is connected to perform communication with the server device and transmits position information to the server device; wherein each of the plurality of game machines includes an information transmitting device which transmits installation information including a game machine code used to individually identify the game machine and a store code used to individually identify the store to the server device, the server device includes a game machine list managing device which manages the installation information transmitted from the plurality of game machines as a game machine list for each game machine, a store list managing device which manages information in which store position information representing the position of the store is associated with the store code as a store list for each store, a store specifying device which specifies the store closest the position represented by the position information received from the user terminal with reference to the game machine list and the store list, and a store information transmitting device which transmits store information of the store specified by the store specifying device to the user terminal, and the user terminal includes a position information acquiring device which acquires position information, a positional information transmitting device which transmits the acquired position information to the server device, a store information receiving device which receives the store information from the server device, and a store information presenting device which presents a user with the store information received by the store information receiving device.

According to the store information presentation system of the present invention, the installation information of the game machine installed in the store is transmitted to the server. The server manages a list related to installation information of each game machine based on the installation information of the game machine received from the game machine. When the user transmits the position information to the server device through the user terminal, a store closest to the position represented by the position information received from the user terminal is specified among stores in which a game machine is installed, and store information of the store is transmitted to the user terminal. The user terminal presents the user with the acquired store information. Thus, when the user desires to play with a game machine, the position information is transmitted from the user terminal, and so a store, in which a game machine is installed, closest to the position represented by the transmitted position information is presented. Thus, the user can visit the presented store and play with a game machine.

As on aspect of the store information presentation system of the present invention, the game machine list managing device updates the game machine list each time the installation information is received from each of the plurality of game machines. According to this, since the list is updated each time the installation information is transmitted, it is possible to determine the store to be presented to the user using the latest information each time. In this aspect, when the game machine list managing device receives the installation information from each of the plurality of game machines and updates the game machine list, the game machine list managing device records an update time in association with a game machine code included in the installation information of an update target, and invalidates information related to the corresponding game machine code when a time from the update time to the current time is a predetermined time or more. According to this, since a record of the game machine list which has not been updated during a predetermined time period is invalidated in the game machine list, when it is difficult to transmit installation information, for example, due to a failure, the state of the game machine is appropriately reflected in the list.

As on aspect of the store information presentation system of the present invention, the installation information further includes vacant seat information representing whether or not a vacant seat is present in the game machine, and the store information transmitting device transmits the store information including the vacant seat information to the user terminal. According to this, the store information presented to the user includes the vacant seat information at present. Thus, since the user can know whether or not a vacant seat is present in the game machine in advance, the user can assure that he/she is likely to play.

As on aspect of the store information presentation system of the present invention, the user terminal includes a map information acquiring device which acquires map information based on the position information acquired by the position information acquiring device and store information acquired by the server device, and the store information presenting device presents the map information in addition to the store information. According to this, by acquiring the map information, a map on which the store's position and the user's position are indicated can be presented to the user.

As the aspect in which the map information acquiring device is disposed, a route between a first point represented by the position information acquired by the position information acquiring device and a second point represented by the store information is indicated on a map represented by the map information acquired by the map information acquiring device. According to this, since a route to a store point is indicated on a map, the user can easily understand a route to a store.

As on aspect of the store information presentation system of the present invention, the position information acquiring device automatically acquires the position information of the user terminal. According to this, since the user terminal automatically acquires its position information, a store to be presented to the user is determined based on the current position of the user holding the user terminal.

The server device of the present invention is a server device which is connected to perform communication with a plurality of game machines installed in stores and a user terminal which transmits position information, comprising: a game machine list managing device which receives installation information including a game machine code used to individually identify the game machine and a store code used to individually identify the store from the plurality of game machines, and manages the installation information as a game machine list for each game machine; a store list managing device which manages information in which the store code is associated with store position information representing the position of the store as a store list for each store; a store specifying device which specifies the store closest to the position represented by position information received from the user terminal with reference to the game machine list and the store list; and a store information transmitting device which transmits store information of the store specified by the store specifying device to the user terminal. The server device of the present invention may function as a server device in the store information presentation system of the present invention.

### Advantageous Effects of Invention

As described above, in the present invention, installation information of the game machine installed in the store is transmitted to the server. The server manages the list related to installation information of each game machine based on the installation information of the game machine received from the game machine. When the user transmits the position information to the server device through the user terminal, a store closest to the position represented by the position information received from the user terminal is specified among stores in which the game machine is installed, and store information of the store is transmitted to the user terminal. The user terminal presents the user with the acquired store information. Thus, when the user desires to play with a game machine, the position information is transmitted from the user terminal, and so a store, in which the game machine that the user desires to play with is installed, closest to the position represented by the transmitted position information is presented. Thus, the user can visit the presented store and play with a game machine.

### BRIEF DESCRIPTION OF DRAWINGS

FIG. 1 is a diagram illustrating the outline of a system configuration of an amusement system to which a store information presentation system is applied according to one aspect of the present invention.

FIG. 2 is a functional block diagram of an amusement system.

FIG. 3 is a flowchart illustrating a process of updating a game machine list at a server.

FIG. 4 is a diagram illustrating a store list.

FIG. 5 is a diagram illustrating a game machine list.

FIG. 6 is a flowchart to describe a process of presenting a user with store information.

FIG. 7 is a diagram illustrating an example of information to be presented to a display device of a user terminal.

### DESCRIPTION OF EMBODIMENTS

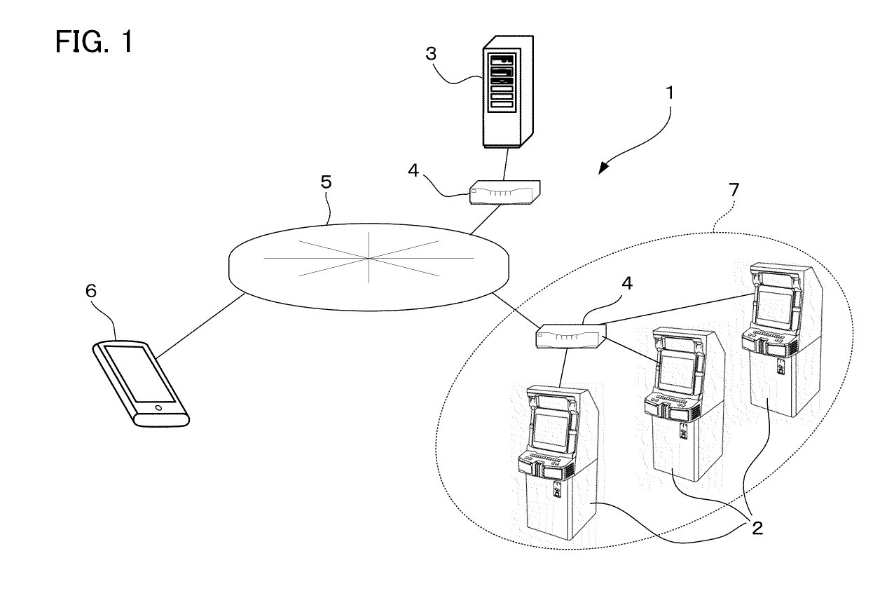

FIG. 1 is a diagram illustrating the outline of a system configuration of an amusement system to which a store information presentation system is applied according to one aspect of the present invention. In an amusement system 1 of this aspect of the present invention, one or more game machines 2 which an operator has installed in commercial facilities (hereinafter, referred to as a “store”) such as amusement facilities are connected to a network 5 to perform communication with a server 3 as a server device managed or operated by a service provider via a router 4. A user terminal 6 is connected to the network 5. For example, the user terminal 6 is a portable terminal such as a mobile telephone or a personal computer (PC), and configured as a device having a network connection function. Each game machine 2 is configured as a commercial game machine that allows a game to be played according to consumption of a predetermined economic value in exchange for the consumption. An appropriate number of game machines 2 are installed in each of a plurality of stores 7.

The server 3 provides the game machine 2 or a player who is a user of the game machine 2 with various services via the network 5. For example, the server 3 provides an update service of a game program or a variety of data stored in the game machine 2, and a service that authenticates the player of the game machine 2 using an ID and a password, stores play data including play history and save data of the player or the like on the server 3, and allows the play data to be appropriately used. FIG. 1 illustrates one server 3, but a plurality of servers 3 may be installed to share processing necessary for the services. Each of the game machine 2 and the server 3 has a unique address identifying itself on the network 5, and a communication partner is specified using the address in communication between the game machines 2 or communication between the game machine 2 and the server 3.

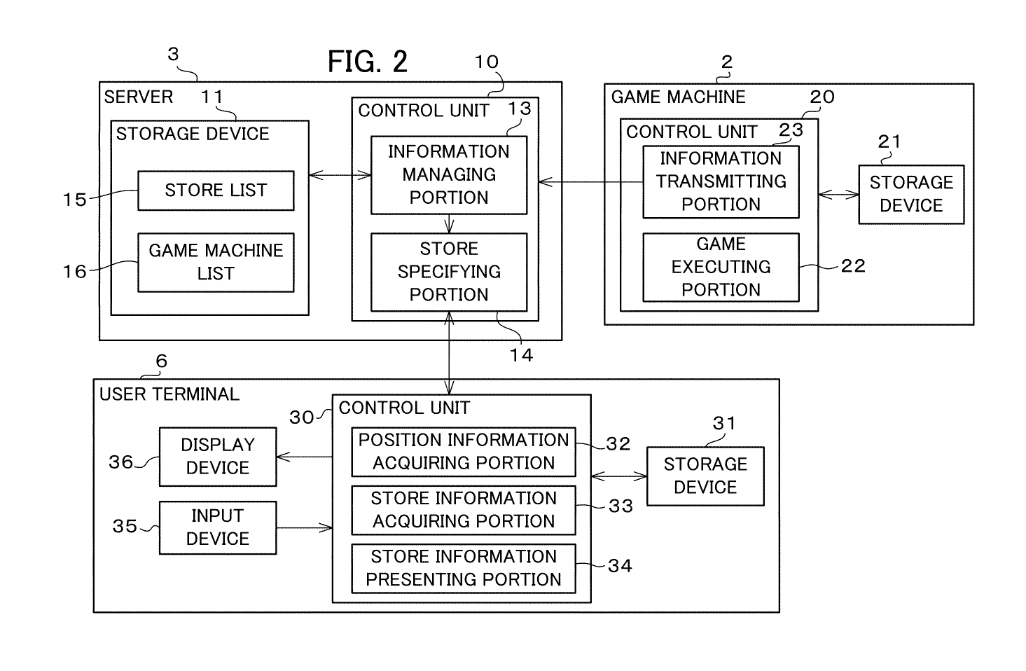

FIG. 2 is a functional block diagram of the amusement system 1. The server 3 of the amusement system 1 is provided with a control unit 10 and a storage device 11. The control unit 10 is a computer unit in which a microprocessor is combined with a peripheral device such as a main storage device necessary for an operation of the microprocessor. Examples of the storage device 11 include a magnetic storage medium, an optical storage medium, and a non-volatile storage medium such as an electrically erasable programmable read-only memory (EEPROM). As the control unit 10 reads and executes a sever program recorded in the storage device 11, an information managing portion 13 and a store specifying portion 14 are implemented in the control unit 10 as logical devices. The information managing portion 13 manages a store list 15 and a game machine list 16 recorded in the storage device 11.

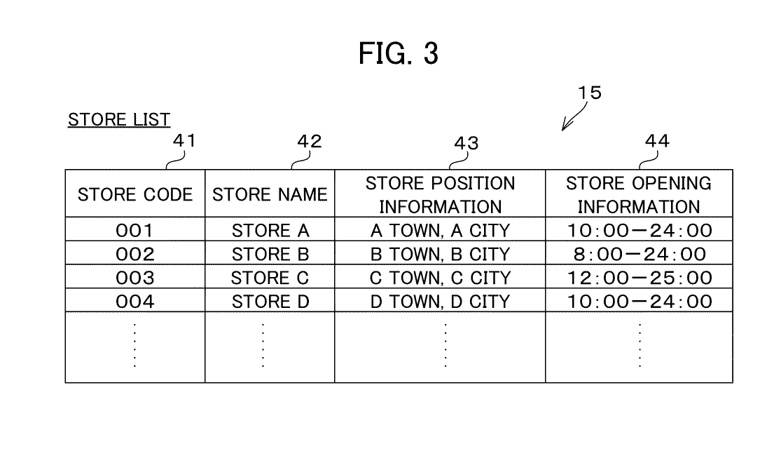

FIG. 3 is a diagram illustrating a data structure of the store list 15 stored in the storage device 11. The store list 15 includes a store code 41, a store name 42, store position information 43, and store opening information 44. The store code 41 is information which is used to identify a store 7 managed by the operator and unique to each store 7. The store name 42 is text information representing a name of the store 7. The store position information 43 is information related to the position of the store 7, and text information representing the address or numerical information representing the latitude and the longitude may be recorded. The store opening information 44 is information related to a business hour of the store 7 including an opening time and a closing time. For example, the service provider adds each piece of information to the store list 15 as a new record when the game machine 2 is installed in a new store in which the game machine 2 is not installed yet. Alternatively, information of all stores in which the game machine 2 can be installed may be recorded in the store list 15 in advance. The information managing portion 13 functions as a store list managing device.

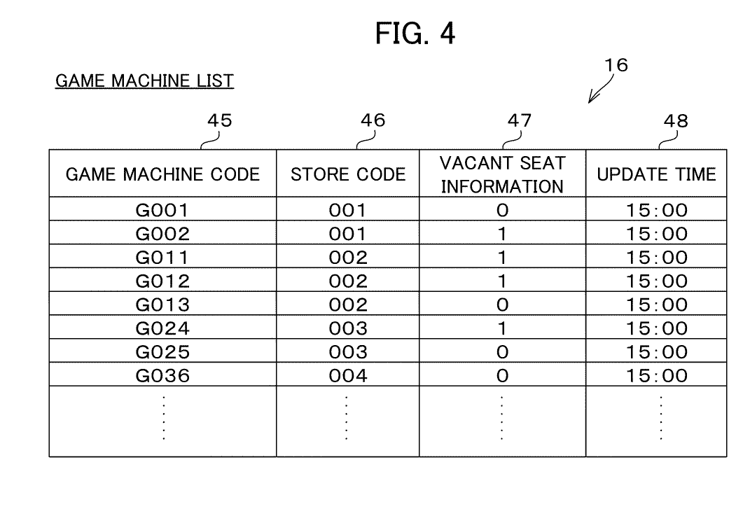

FIG. 4 is a diagram illustrating a data structure of the game machine list 16 stored in the storage device 11. The game machine list 16 is information related to the game machine 2 connected to the server 3, and includes a game machine code 45, a store code 46, vacant seat information 47, and an update time 48. The game machine code 45 is information which is used to identify the game machine 2 and unique to each game machine 2. The store code 46 is information used to identify the store 7, and is the same as the store code 41 in the store list 15. The vacant seat information 47 is information representing whether or not the game machine 2 is being played by the player. When the game machine 2 is being played by the player, “1” representing an in-play state is stored, and when the game machine 2 is not being played by the player, “0” representing a vacant seat state is stored. The update time 48 refers to a time at which a corresponding record in the game machine list 16 is updated.

The server 3 updates the game machine list 16 based on information received from the game machine 2 as necessary. The store specifying portion 14 specifies the store 7 closest to the position represented by the position information received from the user terminal 6 among the stores 7 in which the game machine 2 is installed with reference to the store list 15 and the game machine list 16 stored in the storage device 11. The information of the specified store 7 is transmitted to the user terminal 6 through the control unit 10 of the server 3.

The game machine 2 is provided with a control unit 20 and a storage device 21. The control unit 20 is a computer unit including a microprocessor as a main entity. The storage device 21 may have the same configuration as the storage device 11 of the server 3. As the control unit 20 reads and executes a game machine program recorded in the storage device 21, a game executing portion 22 and an information transmitting portion 23 are implemented in the control unit 20 as logical devices. The game executing portion 22 controls the progress of a game played in the game machine 2. The information transmitting portion 23 transmits game execution information representing a status of a game executed by the game executing portion 22 and installation information which is information which the service administrator or the operator of the store 7 has previously set to the game machine 2 to the server 3. The game execution information includes vacant seat information representing whether or not the game machine 2 is being played, which is determined by the game executing portion 22. The installation information includes a game machine code used to identify the game machine 2 and a store code used to identify the store 7 in which the game machine 2 is installed. The information transmitting portion 23 functions as an information transmitting device.

The user terminal 6 is provided with a control unit 30 and a storage device 31. The control unit 30 is a computer unit including a microprocessor as a main entity. The storage device 31 has the same configuration as the storage device 11 of the server 3 and the storage device 21 of the game machine 2. The user terminal 6 is provided with an input device 35 and a display device 36 which are connected to the control unit 30. As the control unit 30 reads and executes a user terminal program recorded in the storage device 31, a position information acquiring portion 32, a store information acquiring portion 33, and a store information presenting portion 34 are implemented in the control unit 30 as logical device. The position information acquiring portion 32 receives signals from global positioning system (hereinafter, referred to as “GPS”) satellites using a GPS receiver mounted in the user terminal 6, and acquires position information of the user terminal 6. The position information may be acquired using a well-known technique. The store information acquiring portion 33 requests the server 3 to transmit information of the store 7 closest to the position represented by position information of the user such that the control unit 30 includes the position information of the user terminal 6 acquired by the position information acquiring portion 32 in transmission data as position information of the user, and then transmits the transmission data to the server 3. The user terminal 6 receives a response from the server 3, and acquires information of the store 7. The store information presenting portion 34 presents the user with the information of the store 7 acquired by the store information acquiring portion 33.

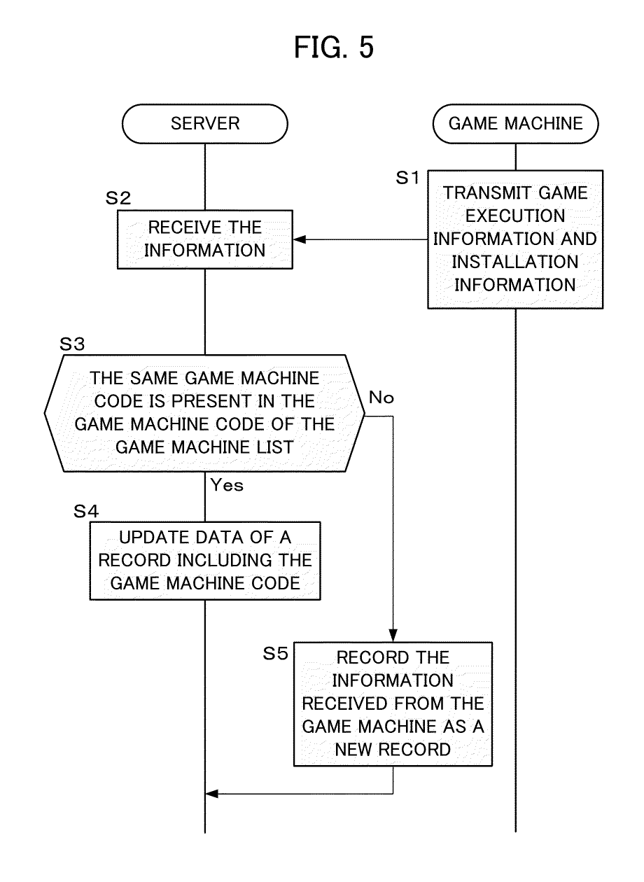

FIG. 5 is a flowchart illustrating a process of managing the game machine list 16 by the information managing portion 13 of the server 3. First, in step S1, the information transmitting portion 23 of the game machine 2 transmits the game execution information and the installation information of the game machine 2 to the server 3. The information is transmitted from the game machine 2 to the server 3 as necessary. In step S2, the information managing portion 13 of the server 3 receives information transmitted from the game machine 2. Then, in step S3, the information managing portion 13 determines whether or not the same game machine code as the game machine code included in the received information is present in the game machine list 16 with reference to the game machine code of the game machine list 16.

In step S3, the information managing portion 13 receives information from the game machine 2 and searches the game machine list 16 using the game machine code included in the received information as a key. When it is determined that the same game machine code is present in the game machine code 45 of the game machine list 16, the process proceeds to step S4. In step S4, the information managing portion 13 updates data of a record including the game machine code based on the information received by the game machine 2, and then the current process ends. However, when the same game machine code is not present in the game machine list 16, the process proceeds to step S5. In step S5, the information managing portion 13 records the information received from the game machine 2 in the game machine list 16 as a new record, and then the current process ends. In steps S4 and S5, a time at which the game machine list 16 is updated is recorded in the update time 48. Each record recorded in the game machine list 16 is invalidated when a time from the update time 48 to the current time is equal to or more than a predetermined time.

According to the above-described process, when the game execution information and the installation information are transmitted from the game machine 2 of each store 7 (step S1), the information is received by the server 3 (step S2). The information managing portion 13 of the control unit 10 of the server 3 determines whether or not the same game machine code as the game machine code included in the received information is present in the game machine codes 45 of the game machine list 16 with reference to the game machine code 45 of the game machine list 16 (step S3). When it is determined that the same game machine code is present in the game machine codes 45 of the game machine list 16, the game machine list 16 is updated based on the information received from the game machine 2 (step S4). However, when it is determined that the same game machine code is not present in the game machine codes 45 of the game machine list 16, the information received from the game machine 2 is recorded in the game machine list 16 as a new record (step S5). As a result, the latest game execution information and the installation information of the game machine 2 are reflected in the game machine list 16. In the above-described process, steps S3 to S5 executed by the control unit 10 of the server 3 function as a game machine list managing device. The processes of steps S3 to S5 are executed by the information managing portion 13.

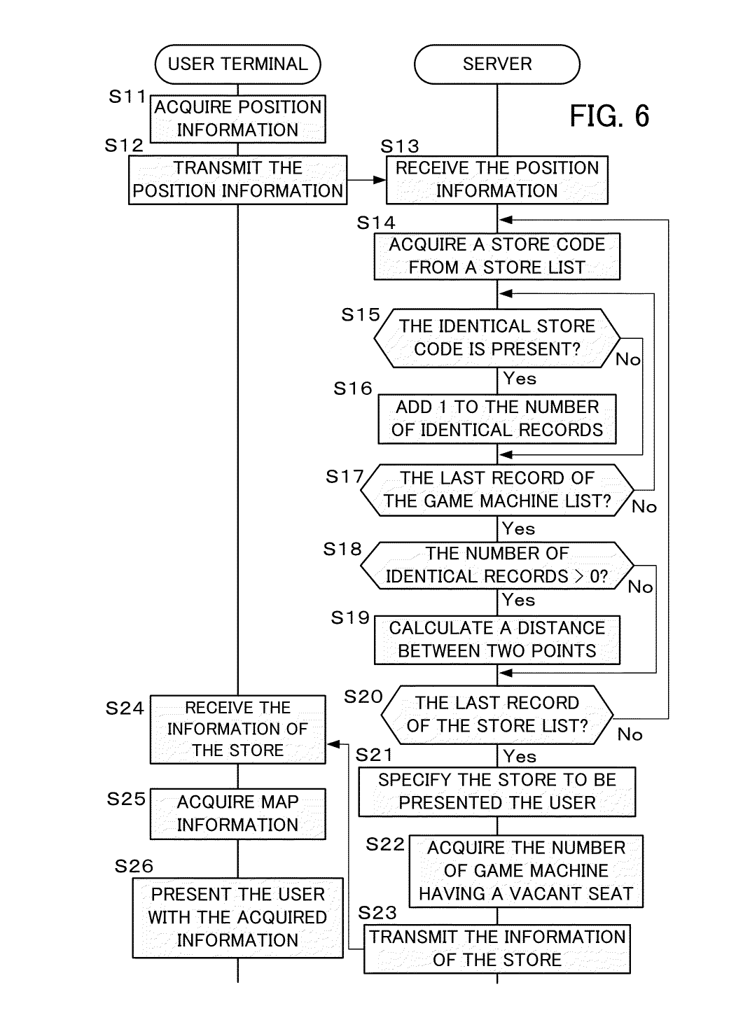

FIG. 6 is a flowchart to describe a process of presenting the user with the information of the store 7 based on the position information which the server 3 has received from the user terminal 6. This process is a process of presenting the user with the store 7 closest to the position represented by the position information which the server 3 has received from the user terminal 6. First, the control unit 30 of the user terminal 6 acquires position information of the user terminal 6 using a GPS receiver mounted in the user terminal 6 in response to the user's operation (step S11).

The control unit 30 of the user terminal 6 puts the position information of the user terminal 6 acquired in step S11 in transmission data as the user's position information, and transmits the resultant transmission data to the server 3 (step S12). The acquisition and transmission of the position information is executed through an application dedicated for the game machine 2 installed in the user terminal 6. The user performs an operation as instructed by the application, and so the position information of the user terminal 6 is acquired and then transmitted to the server 3 as the user's position information. The application may be configured using a well-known technique.

Next, the control unit 10 of the server 3 receives the user's position information transmitted from the user terminal 6 (step S13). In step S14 and subsequent steps, the store specifying portion 14 of the server 3 performs a process of specifying the store 7 closest to the position represented by the user's position information received from the user terminal 6. The control unit 10 acquires a store code included in a certain record from the store list 15 stored in the storage device 11 (step S14). Next, the control unit 10 searches the store code 46 of the game machine list 16 stored in the storage device 11 using the store code acquired in step S14 as a key, and determines whether or not the identical store code is present (step S15). When the identical store code is present, the control unit 10 adds the number of identical records by one (step S16). However, when there is no identical store code, the control unit 10 causes the process to proceed to step S17. The control unit 10 determines whether or not a record in which the store code 46 is searched in step S15 is the last record of the game machine list 16 (step S17). When the corresponding record is not the last record, the control unit 10 causes the process to return to step S15. Then, the control unit 10 extracts a store code to be compared next from the store code 46 of the game machine list 16, and then compares the extracted store code with the store code acquired in step S14 to determine whether or not the extracted store code matches the store code acquired in step S14. The processes of steps S15 to S16 described above are repeatedly performed on the first record to the last record in the game machine list 16.

Next, the control unit 10 determines whether or not the number of identical records counted in step S16 is one or more (step S18). When it is determined that the number of identical records counted in step S16 is one or more, the control unit 10 calculates a distance between two points based on the store position information 43 corresponding to the store code acquired in step S14 in the store list 15 and the user's position information received from the user terminal 6 (step S19). However, when the number of identical records is zero, the control unit 10 skips step S19 and causes the process to proceed to step S20. The control unit 10 determines whether or not the store code acquired in step S14 is the last record of the store list 15 (step S20). When it is determined that the store code acquired in step S14 is not the last record of the store list 15, the control unit 10 causes the process to return to step S14. In step S14, the next store code is acquired, and then the processes of steps S15 to S20 are repeatedly performed on the first record to the last record in the store list 15. Through the processes of steps S13 to S20, the distance between the two points of the store position information corresponding to each store code and the user's position information is calculated on each of all store codes included in the store list 15. The control unit 10 specifies the store 7 to be presented to the user with reference to the distance calculated in step S19 (step S21). A store having store position information that causes the distance between the two points to be minimum is specified as a store 7 to be presented to the user.

In a comparison of the distance between the store position information and the user's position information, when the two pieces of information is numerical information representing the latitude and the longitude, each difference between the two points of the store position information included in each record of the store list 15 and the user's position information is calculated, and the store 7 having store position information causing the difference to be minimum is specified as the store 7 closest to the position represented by the user's position information. When at least one of the store position information and the user's position information is text information representing the address, the text information representing the address may be converted into the numerical information representing the latitude and the longitude, and then the above-described process of calculating the difference between the two points may be performed. A well-known technique may be used as a method of converting the text information representing the address into the numerical information representing latitude and longitude. For example, by transmitting the text information representing the address from the server 3 to a server that is disposed in the outside and provides a position information service via the network 5, the numerical information representing latitude and longitude may be acquired.

After the store 7 to be presented to the user is specified in step S21, the control unit 10 acquires the number of game machines 2, which is in the vacant seat state, in the specified store 7 (step S22). Specifically, the number of records in which the vacant seat information 47 corresponding to the store code of the store 7 specified in step S21 is “0” representing the vacant seat state is counted in the game machine list 16.

The control unit 10 transmits the information of the store 7 specified in step S21 to the user terminal 6 (step S23). All pieces of information including the respective pieces of information 41 to 44 of the store list 15 and the number of game machines 2 in the vacant seat state may be transmitted as the information of the store 7 to be presented to the user, and some pieces of information including the store position information 43 may be selectively transmitted.

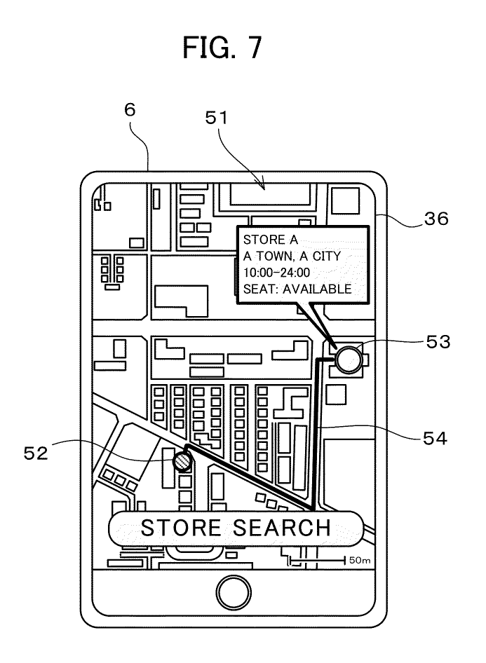

The control unit 30 of the user terminal 6 receives the information of the store 7 transmitted from the server 3 (step S24). Next, map information is acquired based on the position information acquired by the user terminal 6 and the store position information of the store 7 received from the server 3 (step S25). The map information may be acquired using a well-known technique. For example, a variety of map information service being provided via the network 5 may be used. By transmitting the position information acquired by the user terminal 6 and the position information of the store 7 to a server for a map information service, map information including a route that connects the two points may be acquired. Then, the control unit 30 presents the user with the acquired information of the store 7 and the map information by causing the information to be displayed on the display device 36 of the user terminal 6 (step S26). FIG. 7 is a diagram illustrating an example of information presented through the display device 36 of the user terminal 6. The display device 36 displays a position 52 of the user as a first point, a position 53 of the store 7 as a second point, and a route 54 that connects the positions 52 and 53 on a map 51. For example, a store name, the address, store opening information, and vacant seat information of the store 7 may be displayed on the position 53 of the store 7. Information displayed on the display device 36 of FIG. 7 is an example, and information or the layout of the store 7 to be presented may be appropriately changed. Then, the control unit 30 ends the current process.

According to the above-described process, the user operates the user terminal 6 and acquires the position information of the user terminal 6 (step S11), and transmits the acquired position information to the server 3 as the user's position information (step S12). The server 3 specifies the store 7 closest to the position represented by the user's position information based on the store list 15 and the game machine list 16 (steps S14 to S21), and then transmits the specified information of the store 7 to the user terminal 6 (step S23). The user terminal 6 receives the information of the store 7 (step S24), and acquires the map information based on the received information (step S25). Then, the user terminal 6 presents the user with each acquired information by displaying each acquired information through the display device 36 (step S26).

The process of step S11 executed by the control unit 30 of the user terminal 6 functions as a position information acquiring device, the process of step S12 functions as a positional information transmitting device, the process of step S24 functions as a store information receiving device, the process of step S25 functions as a map information acquiring device, and the process of step S26 functions as a store information presenting device. Further, the process of step S11 is executed by the position information acquiring portion 32, the processes of steps S12 and S24 are executed by the store information acquiring portion 33, and the process of step S26 is executed by the store information presenting portion 34. Further, the processes of steps S14 to S22 executed by the control unit 10 of the server 3 function as the store specifying device, and the process of step S23 functions as a store information transmitting device. Further, the processes of steps S14 to S22 are executed by the store specifying portion 14.

The present invention is not limited to the above embodiment and can be embodied by various embodiments. For example, in the present embodiment, the GPS is used to acquire the position information of the user terminal 6, but a technique of acquiring the position information of the user terminal 6 is not limited to this example. For example, the user may input text information such as the address or a place name. In this case, even the user terminal 6 in which the GPS receiver is not implemented can present the user with the information of the store 7 closest to the user's current position. Further, even on the position different from the user's current position, it is possible to present the user with the information of the store 7 closest to the corresponding position. Further, information presented to the user may include route information of a means of transportation. Respective stations nearby the user and the store may be specified based on the user's position information and the store's position information, and route information such as a means of transportation to use or a required time may be presented. The route information may be acquired using various route information services being provided via the network 5. A route that connects the position of a nearby station with the position of the store 7 may be presented. The game machine 2 may have either a form in which a game machine supports one player or a form in which a game machine supports two or more payers. The present invention can be applied to various game machines that provide a medal game, a music game, a shooting game, and the like.

The above embodiment has been described in connection with one type of the game machine 2, but the present invention is not limited to this example. When two or more types of game machines are dealt with, the game machine list 16 may be stored in each of two or more types of game machines, or information about two or more types of game machines may be included in one game machine list 16. Further, the installation information transmitted from the game machine 2 to the server 3 may include information identifying the type of the game machine 2. Further, the information transmitted from the user terminal 6 to the server 3 may include information specifying the type of game machine specified by the user as well as the user's position information. In this case, the control unit 30 of the user terminal 6 functions as a type specifying unit that allows the user to specify the type of game machine. Meanwhile, the server 3 may execute the processes of steps S14 to S22 based on the information specifying the type of game machine.

The user terminal 6 may access the server 3 through a web site constructed by the service administrator. In this case, the type of game machine may be specified by causing the user to select a specific type of game machine among two or more types of game machines or causing the user to input information specifying the type of game machine. Alternatively, the user terminal 6 may access the server 3 through a web site specially provided for a specific type of game machine. The type of game machine is specified by access using a web site. Alternatively, applications, which respectively correspond to two or more types of game machines, installed in the user terminal 6 may be used to access the server 3.

The respective pieces of information 41 to 48 in the store list 15 of FIG. 3 and the game machine list 16 of FIG. 4 are exemplary, and the present invention is not limited to this example. For example, appropriate information such as the size of the store 7 or the presence or absence of a game machine in which the user has an interest may be added. Further, each piece of information present in the store list 15 as well as the store position information of the store 7 may be appropriately selected as information of the store 7 to be presented to the user from the store list 15.

Further, in step S21, the control unit 10 of the server 3 specifies the store 7 to be presented to the user, but the number of stores 7 to be presented to the user is not limited to one. For example, a plurality of stores 7 may be extracted as candidates based on the user's position information and the position information of the store 7, and information of the plurality of stores 7 may be presented in the ascending order of the distance from the user's position. Further, the user may decide the number of stores 7 to be presented. Further, the store 7 having many game machines 2 which are in the vacant seat state may be preferentially displayed based on the vacant seat information 47 of the game machine list 16.

What is claimed is:

1. A store information presentation system comprising:
a plurality of game machines which are installed in stores;
a server device which is connected to perform communication with the plurality of game machines; and
a user terminal which is connected to perform communication with the server device and transmits position information to the server device; wherein
each of the plurality of game machines includes an information transmitting device which transmits installation information including a game machine code used to individually identify the game machine and a store code used to individually identify the store to the server device,
the server device includes a game machine list managing device which manages the installation information transmitted from the plurality of game machines as a game machine list for each game machine, a store list managing device which manages information in which store position information representing the position of the store is associated with the store code as a store list for each store, a store specifying device which specifies the store closest the position represented by the position information received from the user terminal with reference to the game machine list and the store list, and a store information transmitting device which transmits store information of the store specified by the store specifying device to the user terminal, and
the user terminal includes a position information acquiring device which acquires position information, a positional information transmitting device which transmits the acquired position information to the server device, a store information receiving device which receives the store information from the server device, and a store information presenting device which presents a user with the store information received by the store information receiving device.

2. The store information presentation system of claim 1, wherein
the game machine list managing device updates the game machine list each time the installation information is received from each of the plurality of game machines.

3. The store information presentation system of claim 2, wherein
when the game machine list managing device receives the installation information from each of the plurality of game machines and updates the game machine list, the game machine list managing device records an update time in association with a game machine code included in the installation information of an update target, and invalidates information related to the corresponding game machine code when a time from the update time to the current time is a predetermined time or more.

4. The store information presentation system of claim 1, wherein
the installation information further includes vacant seat information representing whether or not a vacant seat is present in the game machine, and
the store information transmitting device transmits the store information including the vacant seat information to the user terminal.

5. The store information presentation system of claim 1, wherein
the user terminal includes a map information acquiring device which acquires map information based on the position information acquired by the position information acquiring device and store information acquired by the server device, and
the store information presenting device presents the map information in addition to the store information.

6. The store information presentation system of claim 5, wherein
a route between a first point represented by the position information acquired by the position information acquiring device and a second point represented by the store information is indicated on a map represented by the map information acquired by the map information acquiring device.

7. The store information presentation system of claim 1, wherein
the position information acquiring device automatically acquires the position information of the user terminal.

8. A server device which is connected to perform communication with a plurality of game machines installed in stores and a user terminal which transmits position information, comprising:
a game machine list managing device which receives installation information including a game machine code used to individually identify the game machine and a store code used to individually identify the store from the plurality of game machines, and manages the installation information as a game machine list for each game machine;
a store list managing device which manages information in which the store code is associated with store position information representing the position of the store as a store list for each store;
a store specifying device which specifies the store closest to the position represented by position information received from the user terminal with reference to the game machine list and the store list; and
a store information transmitting device which transmits store information of the store specified by the store specifying device to the user terminal.
